(19) United States
(12) Patent Application Publication
(10) Pub. No.: US 2010/0107696 A1
(43) Pub. Date: May 6, 2010

(54) METHOD FOR REDUCING INCLUSIONS IN SILICA-TITANIA GLASS

(76) Inventors: John Edward Maxon, Canton, NY (US); Eli F. Tracy, Hermon, NY (US); William J. Whispell, Potsdam, NY (US)

Correspondence Address: CORNING INCORPORATED, SP-TI-3-1, CORNING, NY, 14831, US

(21) Appl. No.: 12/261,694

(22) Filed: Oct. 30, 2008

(51) Int. Cl. C03B 32/00

(52) U.S. Cl. 65/66

(57) ABSTRACT

The invention in one aspect is directed to a silica-titania glass have reduced striae and reduced inclusions, the glass have a point-to-point variation in titania content is 0.1 wt % or less through its thickness and a CTE of 0±3 ppb/° C. in the temperature range 5-35° C. The invention is further directed to a method for producing by using a method in which the time for repetition of the oscillation patterns used in the process are 10 minutes or less during preparation of the glass and after the glass has been prepared heating the glass at a temperature in the range of 1650-1700° C. for a time in the range of 4-10 day to reduce inclusions in the glass.

### RELATED APPLICATION

This application is related to U.S. patent application Ser. No. 11/445,048 titled REDUCED STRIAE LOW EXPANSION GLASS AND ELEMENTS, AND A METHOD FOR MAKING SAME” filed May 31, 2006 in the name of inventors John E. Maxon and William R. Rosch.

### FIELD

This invention relates to extreme ultraviolet elements made from glasses including silica and titania. In particular, the invention relates to a method for reducing inclusions in such glasses by means of a selected heat treatment after manufacture of a silica-titania glass boule.

### BACKGROUND

Ultra low expansion glasses and soft x-ray or extreme ultraviolet (EUV) lithographic elements made from silica and titania traditionally have been made by flame hydrolysis of organometallic precursors of silica and titania. Ultra-low expansion silica-titania articles of glass made by the flame hydrolysis method are used in the manufacture of elements used in mirrors for telescopes used in space exploration and extreme ultraviolet or soft x-ray-based lithography. These lithography elements are used with extreme ultraviolet or soft x-ray radiation to illuminate, project and reduce pattern images that are utilized to form integrated circuit patterns. The use of extreme ultraviolet or soft x-ray radiation is beneficial in that smaller integrated circuit features can be achieved, however, the manipulation and direction of radiation in this wavelength range is difficult. Accordingly, wavelengths in the extreme ultraviolet or soft x-ray range, such as in the 1 nm to 70 nm range, have not been widely used in commercial applications. One of the limitations in this area has been the inability to economically manufacture mirror elements that can withstand exposure to such radiation while maintaining a stable and high quality circuit pattern image. Thus, there is a need for stable high quality glass lithographic elements for use with extreme soft x-ray radiation.

One limitation of ultra low expansion silica-titania glass is that the glass contains inclusions in addition to striae. Inclusions in silica-titania glass made by flame hydrolysis, the direct method, vertical axial deposition and other methods known in the art that utilize pure starting materials such as silicon and titanium halides and organometallics generally take the form of small voids of trapped pockets of gas. Inclusions in a finished element (mirror, lens, prism, etc) can cause the radiation passing through or impinging on the element to shift direction and/or diffuse if it passes through the element. In the case of laser lithographic elements any shift in direction and/or diffusion of the radiation will affect the elements [performance and the precision of any product made as a result of using the radiation in combination with the element. Striae, on the other hand, are compositional inhomogeneities which adversely affect optical transmission in lens and window elements made from the glass. Striae can be measured by a microprobe that measures compositional variations that correlate to coefficient of thermal expansion (CTE) variations of a few ppb/° C. Inclusions are generally harder to remove then striae. There are two types of inclusions, gaseous and solid, with solid inclusions being harder to remove than gaseous inclusions. The removal of solid inclusions requires temperatures that would affect the properties of the silica-titania glass.

In addition to methods for prevention the occurrence of striae in silica-titania glass, it would be advantageous to provide a method for removing inclusions, if any, in such glass, or at least minimizing the number of inclusions.

### SUMMARY

The invention is directed to reducing inclusions in low expansion silica-titania glass by heat treating the glass after formation of a silica-titania glass boule.

The invention is directed to a method for reducing striae and inclusions in an ultra-low expansion silica-titania glass, and to optical elements made therefrom, in which a silica-titania consolidated glass boule is prepared in a rotating vessel in a furnace using short oscillation periods as described herein; heat treating the boule at a temperature in the range of 1600-1700° C. for a time in the range of 48-160 hours, preferably 48-96 hours, and cooling the consolidated boule from the 1600-1700° C. range to 1000° C. at a rate in the range of 25-75° C. per hour, for example at approximately 50° C. per hour, followed by cooling to ambient temperature at the natural cooling rate of the furnace to thereby yield a silica-titania glass boule having reduced striae. In an embodiment of this invention the glass boule is prepared by flame hydrolysis using silica and titania precursors selected from the group consisting of siloxanes and alkoxides and tetrachlorides of silicon and titanium. The preferred precursors are titanium isopropoxide and octamethylcyclotetrasiloxane. After the boule has been manufactured and cooled, the boule is placed in a heat treating furnace and its temperature is raised from ambient temperature to approximately 1000° C. at a rate in the range of 20-60° C./hr while the boule is oscillating and rotating according to the teachings herein or the United States patents cited herein. The temperature of the boule is then raised to a temperature in the range of 1650-1700° C. and the boule is held at this temperature from a time in the range of 4-10 days. In one embodiment the temperature was in the range of 1650-1660° C. and the time was in the range of 5-7 days. Temperature excursions up to ˜1700° C. are permitted and can be programmed into the heating schedule. Such excursions, then planned can occur every 24-48 hours. After the heat treatment the boule was cooled to ambient temperature according to a selected cooling schedule of by turning off the furnace's heat source and allowing the furnace to naturally cool to ambient temperature. Any programmed cooling schedule known in the art can be used in practicing the invention. An example of such program is cooling from the 1600-1700° C. range to ˜1000° C. at a rate in the range of 25-75° C./hr followed by cooling to ambient temperature at the natural cooling rate of the furnace.

In another embodiment the invention is directed to heat-treating a low expansion glass at a temperature in the range of 1650-1700° C. for a time in the range of 4-10 days to reduce inclusions.

In a further embodiment the invention is directed to a method of reducing striae in a large boule of glass or in a segment of glass obtained from a large boule by heat treating the glass at a temperature in the range of 1600-1700° C. for a time in the range of 48-160 hours without forcing the glass to flow or “move”; and during the heat treatment the glass is rotated about an vertical axis, and the heat source is uniformly distributed across the horizontal dimensions of the glass. After the boule has been manufactured and cooled, the boule is placed in a heat treating oven and its temperature is raised from ambient temperature to approximately 1000° C. at a rate in the range of 20-60° C./hr while the boule is oscillating and rotating according to the teachings herein or the United States patents cited herein. The temperature of the boule is then raised to a temperature in the range of 1650-1700° C. and the boule is held at this temperature from a time in the range of 4-10 days. In one embodiment the temperature was in the range of 1650-1660° C. and the time was in the range of 5-7 days. Temperature excursions up to ˜1700° C. are permitted and can be programmed into the heating schedule. Such excursions, then planned can occur every 24-48 hours. After the heat treatment the boule was cooled to ambient temperature according to a selected cooling schedule of by turning off the furnace's heat source and allowing the furnace to naturally cool to ambient temperature. Any programmed cooling schedule known in the art can be used in practicing the invention. An example of such program is cooling from the 1600-1700° C. range to ˜1000° C. at a rate in the range of 25-75° C./hr followed by cooling to ambient temperature at the natural cooling rate of the furnace.

In one embodiment the invention is directed to a method for reducing inclusions in a silica-titania boule, the method have the steps consisting of obtaining a silica-titania glass boule; turning the boule upside-down such that the faces that were the top and bottom faces during manufacturing are reversed when the boule is placed on a surface; placing the boule in said upside-down position on a bed of crushed refractory material in a furnace; heating the boule to a temperature of approximately 1000° C. at a heating rate in the range of 20-60° C./hr while rotating and oscillating the boule; heating the boule to a temperature in the range of 1650-1700° C. at a rate in the range of 40-100° C., with slow-down in heating rate as the temperature approaches 1650° C. while rotating and oscillating the boule; holding the boule at a temperature in the 1650-1700° C. for a time in the range of 4-10 days while rotating and oscillating the boule; and cooling the boule to ambient temperature by turning off the heat to the furnace and allowing the to obtain a silica-titania glass boule having reduced inclusions relative to a boule that is not heat treated at a temperature in the 1650-1700° C. for a time in the range of 4-10 days.

### BRIEF DESCRIPTION OF THE DRAWINGS

FIG. 1 is an illustration of a prior art apparatus that can be used for manufacturing silica-titania ultra low expansion glasses.

FIG. 2 illustrates placement of the boule in a furnace on a bed of a refractory material.

FIG. 3 illustrates the heat treatment profile of a boule as measured using glass pyrometers at a radius of ˜5.1 cm and ˜69 cm.

FIG. 4 illustrates inclusions in a boule before and after heat treatment according to the invention.

### DETAILED DESCRIPTION

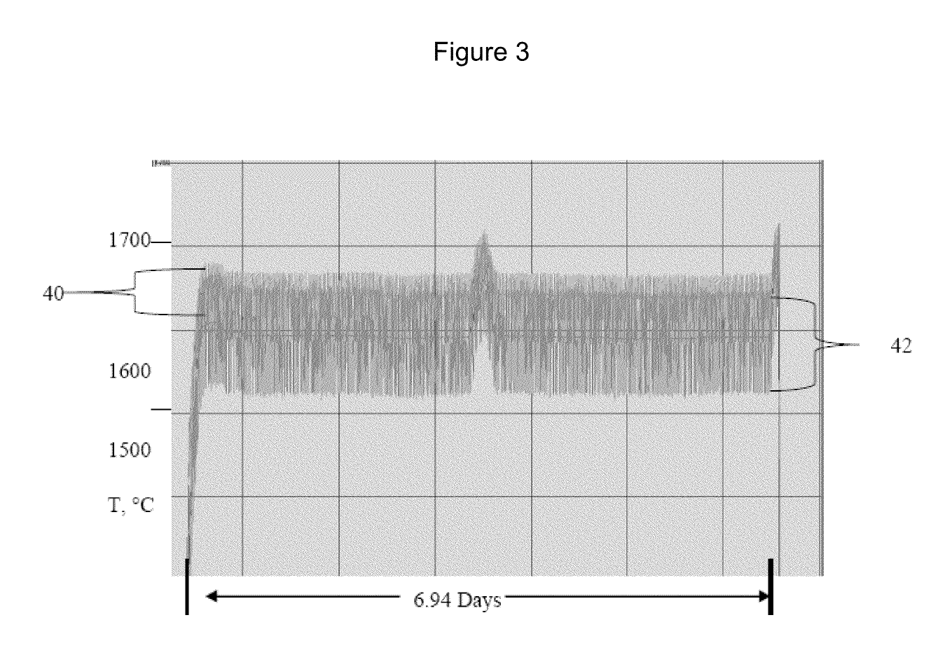

As used herein the term “boule” means any silica-titania glass body having a size in the range of 0.1 meter (“m”) to 2 meters in one or two dimensions and a thickness in the range of 1 cm to 225 cm. For example, one can form a circular boule having a diameter of 0.5 meter and a thickness of 10 cm, or one can form a “boule” whose length and width are 15 cm and whose thickness is 7 cm. The boule can be formed directly by any method known in the art or it can be formed by consolidation of a glass preform made by any method known in the art. The silica and titania precursors used to for a silica-titania glass can be any silicon and titanium halide or organometallic compound known in the art, or mixtures thereof Lastly, the temperatures given herein are measured at the crown of the furnace unless otherwise specified. Typically these temperatures are about 10-20° C. lower than the actual temperature of the glass (see FIG. 3). However, crown temperatures, which are measured at the center of the hot surface of the crown from the inside roof of the furnace, are easier to obtain than actual boule temperatures and are typically used in manufacturing processes, annealing and other processes such as those described herein.

U.S. Pat. No. 5,970,751 describes a method and apparatus for preparing fused silica-titania glass. The apparatus includes a stationary cup or vessel. U.S. Pat. No. 5,696,038 describes using oscillation/rotation patterns for improving off-axis homogeneity in fused silica boules using a prior art rotating cup as described therein. As disclosed in U.S. Pat. No. 5,696,038, the x-axis and y-axis oscillation patterns were defined by the equations:

x(t)=r₁ sin 2 πω₁t+r₂ sin 2πω₂t

y(t)=r₁ cos 2 πω₁t+r₂ cos 2πω₂t

where x(t) and y(t) represent the coordinates of the center of the boule as measured from the center of the furnace ringwall as a function of time (t) measured in minutes. The sum of r₁ and r₂ (r₁ and r₂ are the radii of the offsets; that is the rotation acts like a rotating table on top of 2 other rotating tables offset by the r's) must be less than the difference between the radius of the ringwall and radius of the containment vessel or cup to avoid contact between these structures during formation of the boule. The parameters r₁, r₂, ω₁, ω₂, and a fifth parameter, ω₃, which represents the boule's rotation rate about its center in revolutions per minute (rpm) define the total motion of the boule. Typical prior art values for ω₁, ω₂ and ω₃ used in the manufacture of titania-containing silica boules are 1.71018 rpm, 3.63418 rpm and 4.162 rpm, respectively, and these parameters were used herein.

U.S. Patent Application Publication No. 2004/0027555 describes a method for producing low expansion, titania-containing silica glass bodies by depositing titania-containing glass soot. The method in U.S. 2004/0027555 uses the apparatus described in U.S. Pat. No. 5,970,751 and the rotating/oscillating cup described in U.S. Pat. No. 5,696,038. Silica-titania soot is deposited in a vessel mounted on an oscillating table and the striae level is reduced by altering the oscillation pattern of the table, particularly by increasing the rotation rate of the table. In particular, U.S. 2004/0027555 states that it was found that increasing the values for each of ω₁, ω₂, and ω₃ reduces striae values. Publication 2004/0027555 describes other factors that impact striae and steps that can be taken to counteract their formation. For example, it describes the determination that the flows through the exhaust ports or vents of the furnace impact striae and that striae could be lessened by increasing the number of vents or exhaust ports.

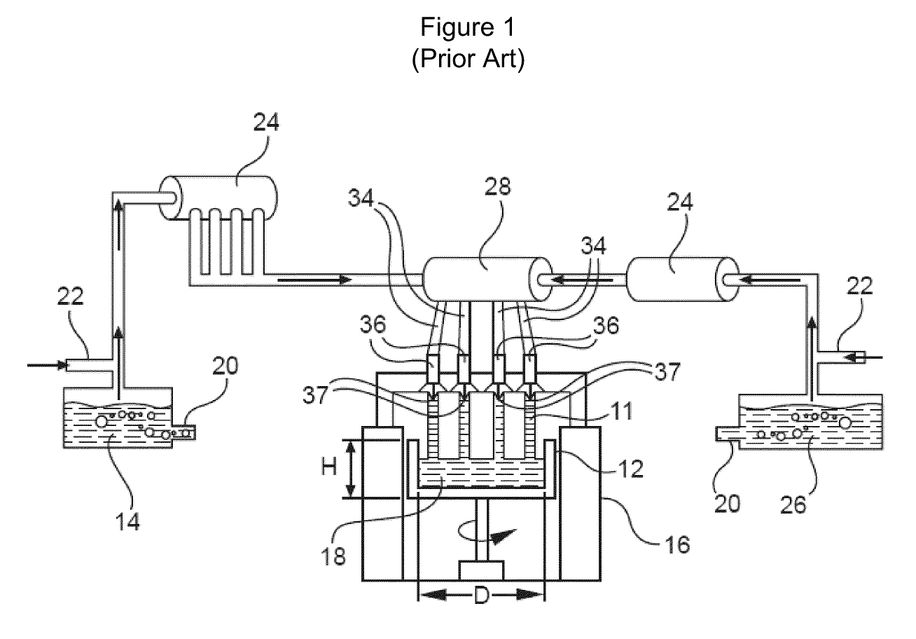

U.S. Patent Application Publication No. 2007/0137252 describes an additional method of preparing a boule and reducing striae. As a first step, a silica-titania glass boule was prepared according to any method known in the art; for example, by the method described in U.S. Pat. No. 5,696,038 using the apparatus as described in Application No. 2004/0027555, which apparatus is also illustrated in Patent Publication No. 2007/0137252 as FIG. 1. The ω₁, ω₂ and ω₃ values used in the manufacture of titania-containing silica boules described herein are 1.71018 rpm, 3.63418 rpm and 4.162 rpm, respectively. After the boule was manufactured, striae were reduced by holding the silica-titania glass boule at a temperature in excess of 1600° C. (as indicated by the furnace crown temperature) for a time in the range of 72-160 hours, preferably 72-96 hours (approximately 3-4 days). In certain embodiments the temperature ranges were described as being in the range of 1600-1700° C. and in the approximate range of 1650±25° C. After the temperature hold for a time as indicated above, the glass was force-cooled at a rate in the range of 25-75° C. per hour, for example at a rate of approximately 50° C. per hour, down to 1000° C. and then allowed to cool at furnace cooling rate to ambient temperature (the temperature of the room surrounding the furnace). The burners were arranged so that they covered all radii of the glass sample being heated and the gas flows to the burners were sufficient to achieve and maintain the temperatures specified herein. When the boule was cooled to ambient temperatures, the boule could be cut, cored or otherwise processed into shapes (“blanks”) that are suitable for making optical elements. Such processing, in addition to cutting or coring, may include etching, additional thermal treatments, grinding, polishing, applying selected metals to form a mirror, and such additional processing as may be necessary to form the desired optical element.

While the above method produced boules with a low striae value, there were inclusions in the glass. While selected blanks of the boule could be used for different parts having different inclusion requirements, the process of testing the entire boule for inclusions and selective matching blanks with the requirements for different applications if laborious and expensive. Hence, a method for reducing inclusions in the entire boule was sought, such method being described in detail in paragraphs that follow.

### EXAMPLE 1

### Boule Preparation

In the manufacturing of Silica-titania boules, the furnace substrate (and the boule) is oscillated and rotated to achieve uniform radial composition and CTE as described in U.S. Pat. No. 5,970,751 A, whose teachings (along with those of the other U.S. patents cited herein) are incorporated by reference. The equations of motion, where rotation is in rpm, used to make ULE low expansion glass, as also given above, are:

i. x-axis=x(t)=r₁ sin 2 πω₁t+r₂ sin 2πω₂t Eq. 1

ii. y-axis=y(t)=r₁ cos 2 πω₁t+r₂ cos 2πω₂t Eq. 2

iii. Rotation=ω₃t Eq. 3

Eq. 1 and 2 describe the oscillation and Eq. 3 describes the rotation of the entire boule.

Referring to the apparatus described in FIG. 1 herein, a titania-containing silica glass boule was manufactured using a high purity silicon-containing feedstock or precursor 14 and a high purity titanium-containing feedstock or precursor 26. The feedstock or precursor materials are typically siloxanes, alkoxides and tetrachlorides containing titanium or silicon. Siloxanes and alkoxides of silicon and titanium are preferred. One particular commonly used silicon-containing feedstock material is octamethylcyclotetrasiloxane, and one particular commonly used titanium-containing feedstock material is titanium isopropoxide, both of which were used herein. An inert bubbler gas 20 such as nitrogen was bubbled through feedstocks 14 and 26, to produce mixtures containing the feedstock vapors and carrier gas. An inert carrier gas 22 such as nitrogen was combined with the silicon feedstock vapor and bubbler gas mixture and with the titanium feedstock vapor and bubbler gas mixture to prevent saturation and to deliver the feedstock materials 14, 26 to a conversion site 10 within furnace 16 through distribution systems 24 and manifold 28. The silicon feedstock and vapor and the titanium feedstock and vapor were mixed in a manifold 28 to form a vaporous, titanium-containing silica glass precursor mixture which was delivered through conduits 34 to burners 36 mounted in the upper portion 38 of the furnace 16. The burners 36 produce burner flames 37. Conversion site burner flames 37 are formed with a fuel and oxygen mixture such as methane mixed with hydrogen and/or oxygen, which combusts, oxidizes and converts the feedstocks at temperatures greater than about 1600° C. into soot 11. The burner flames 37 also provide heat to consolidate the soot 11 into glass. The temperature of the conduits 34 and the feedstocks contained in the conduits are typically controlled and monitored in minimize the possibility of reactions prior to the flames 37.

The feedstocks were delivered to a conversion site 10, where they were converted into titania-containing silica soot particles 11. The soot 11 was deposited in a revolving collection cup 12 located in a refractory furnace 16 typically made from zircon and onto the upper glass surface of a hot silica-titania glass body 18 inside the furnace 16. The values for ω₁, ω₂ and ω₃ used in the manufacture of the titania-containing silica boules were 1.71018 rpm, 3.63418 rpm and 4.162 rpm, respectively. The soot particles 11 consolidate into a titania-containing high purity silica glass body.

The cup 12 typically had a circular diameter shape of between about 0.2 meters and 2 meters so that the glass body 18 is a cylindrical body having a diameter D between about 0.2 and 2 meters and a height H between about 2 cm and 20 cm. The weight percent of titania in the fused silica-titania glass can be adjusted by changing the amount of either the titanium feedstock or silicon-containing feedstock delivered to the conversion site 10 that is incorporated into the soot 11 and the glass 18. The amount of titania and/or silica is adjusted so that the glass body has a coefficient of thermal expansion of about zero at the operating temperature of an EUV or soft x-ray reflective lithography or mirror element.

After the powders have been collected in the cup they are consolidated into a glass boule. Typically, temperatures above 1600° C. are sufficient to consolidate the powder into a glass boule; for example, a temperature in the range 1645-1655° C. After consolidation the boule was heat treated at a temperature in the range of 1600-1700° C. for a time in the range of 72-96 hours to reduce striae and then cooled to ambient temperature; for example by force-cooling at a rate in the range of 25-75° C./hr down to 1000° C. followed by cooling to ambient temperature at the natural cooling rate of the furnace. The boule was removed from the furnace for further processing in accordance with the present invention. When the boule is removed from the furnace, either the entire boule can be returned to a furnace for processing according to the invention or a segment of the boule can be cored. The cores are taken through the depth of the boule and heat treated according to the invention to reduce inclusions.

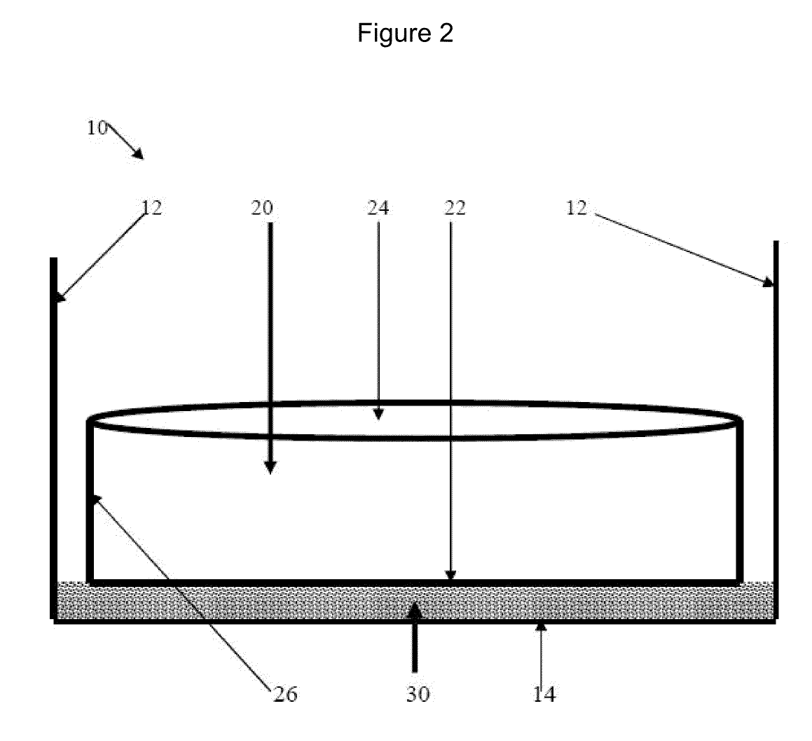

After the boule has been removed from the furnace its samples are cleaned, polished (typically fire-polished) and then inspected using a 300,000 lux light to check for inclusions. If the inspection indicates that inclusion reduction is necessary, then the inclusions can be reduced as follows. The advantage of using this method to reduce inclusions is that the yield of silica-titania blanks that do not contain inclusions is increased. In addition, heat treating to reduce inclusions in a step separate from that of making the boule allows the use of higher temperatures with a reduced risk of boule checks and breakage because the process includes the use of a refractory material to surround the boule during the heating process. A boule 20 is illustrated in FIG. 2. In the manufacturing process the boule 20 top face is 22, the bottom face is 24 and the sides are 26.

The method of the invention includes the following general steps:
a. The boule is into a furnace and is placed on top of a refractory material.
b. The furnace containing the boule is slowly heated to a temperature of approximately while the boule is rotating and oscillating
c. The boule is then more rapidly heated to a temperature in the range of >1650-1700° C.
d. The boule is held above 1650° C. for a time in the range of 4-10 days.
e. The boule is then cooled down to ambient temperature and checked for inclusions.

FIG. 2 illustrates the set-up for heat treating to reduce. In FIG. 2 a boule 20 of approximately 150 cm diameter and 25 cm thickness was placed on top of a bed 30 of refractory material inside a furnace 10 having walls 12 and a base 14. The refractory material 30 is also placed between the side 26 of boule 20 and the walls 12 of furnace 10 to prevent sideways motion of the boule while it is being rotated and oscillated during the heating process. Furnace elements such as the crown, heating elements or jets, temperature sensors, controllers, insulation and similar have not been illustrated to simplify the depiction of the process. While the boule can be placed in furnace with the faces being in the same relative position as in manufacturing, in one embodiment it is preferred the boule be placed in the heat treating furnace 10 in an upside down position such that top face 22 is in contact with the bed of refractory material. The top face 22 is the face most likely to have defects and/or the highest striae variations resulting from the manufacturing process which will require the removal of some thickness of material from the boule. By placing the top face on top of the refractory material, which can cause additional damage during the heat treatment to remove inclusions, the amount of material needed to be removed from the boule after heat treating is minimized.

### EXAMPLE 2

### Inclusion Inspection and Reduction by Heat Treatment

A silica-titania boule prepared by the method(s) described herein was cleaned and inspected for inclusions using a 300,000 light. The light makes the inclusions visible and they are manually counted by applying a grid template to boule surface and counting the inclusion in each grid. After inspecting and positioning the boule in the furnace, the boule was slowly heated to a temperature of approximately 1000° C. The heating was carried out at a rate in the range of 20-60° C./hr while the boule was rotating and oscillating. The temperature was then increased to a temperature in range of 1650-1700° C. at a faster heating rate, for example, heating at a rate in the range of 40-100° C./hr, with slow-down of this rate as the temperature approached 1650° C. The temperature was then held within the range of 1650-1700° C. for a time in the range of 4-10 days. In one embodiment the temperature was in the range of 1650-1660° C. and the time was in the range of 5-7 days. In another embodiment the temperature was in the range of 1650-1660° C. with temperature excursions to 1700° and the time approximately 6 days. The temperature excursions can be planned to occur (for example, every 24-48 hours) or they can be an inadvertent result due to the controller. In order to insure that the temperature does not exceed 1700° C., at least one over-temperature control sensor is placed in the furnace. Temperature measurements are in the area between the crown (top) of the furnace and the surface of the boule.

After the heat treatment the boule was cooled to ambient temperature. Cooling was done using a pre-determined schedule or simply turning off the heat to the furnace and allowing the furnace to cool at its natural rate. The boule was removed from the furnace when the furnace temperature was below approximately 75° C. After the boule has cooled material was removed from the boule surface that was in contact with the refractory material. Inclusions were again counted in the same manner as described above. The number of inclusion before and after heat treatment were “normalized” by the ratio of the boule thickness to account for some that may have been present in the stock material than was removed from the face in contact with the refractory bed.

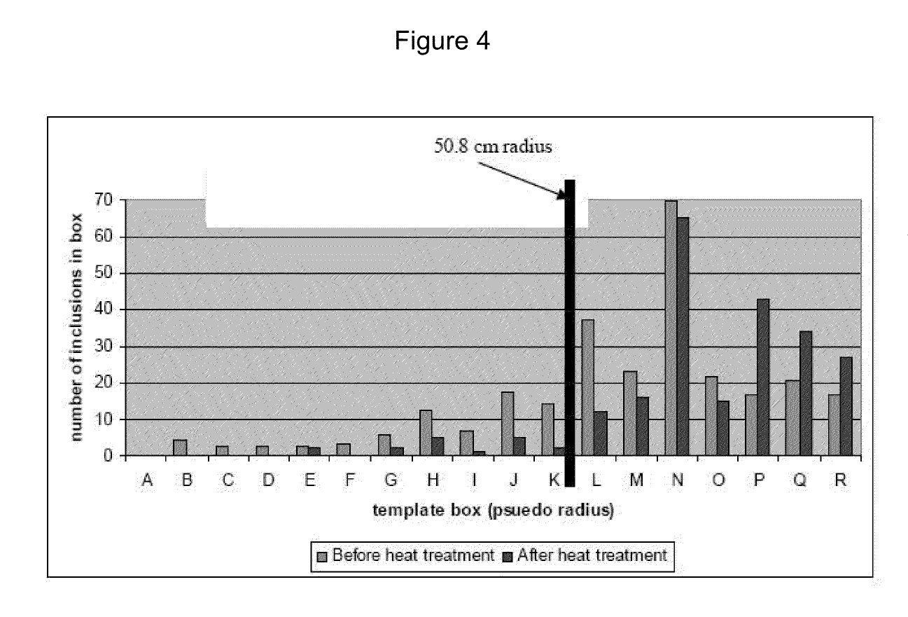

FIG. 4 shows the results of heat treatment to reduce inclusions. The results indicate that the number of inclusions was reduced from 145 before heat treatment to 35 (a inclusion reduction of 75% after heat treatment at radii of <61 cm. In addition, the number of inclusions at radii >61 cm did not substantially change as a result of the heat treatment. It is believe that there are two possible reasons for these results.

The first reason is that at the outer diameter of the boule (>61 cm) there are more soot and seed defects which do not respond to heat treatment then there are closer to the center of the boule, For example, the region >62 cm has a higher percentage of inclusion that do not respond to heat treatment; e.g., TiO₂ rich particles.

The second reason is that during the heat treatment the boule was hotter at radii <61 cm than it was at radii >61 cm. FIG. 3 is a temperature profile of a boule that was hest treated for 6.9 days. The temperature of the horizontal area that stretches horizontally across the graph as defined by bracket 40 was measured at a radius of 5.1 cm and the temperature of the area defined by bracket 42 was measured at a radius of 69 cm. Area 40 stayed within the 1650-1700° C. temperature range (average value about 1670°), except for brief excursion to ˜1700° C. In contrast, area 42 was below 1650° C., except for temperature excursions, and had an average value of about 1640° C.

In addition to treating large glass boules as described in the foregoing paragraphs, the method of the invention can be used to remove inclusions from cores taken from a large boule or made directly using a smaller cup; for example, boules having a diameter of 15-26 cm and a thickness of 5-10 cm. When smaller boules are processed the processing temperature(s) remains the same ad for larger boules, but the durations can very slightly, though it should not be less than four days so that inclusions can migrate to the outer faces and sides of the boule. Typically, small boules should be heat treated for a time in the range of 4-6 days.

While the invention has been described with respect to a limited number of embodiments, those skilled in the art, having benefit of this disclosure, will appreciate that other embodiments can be devised which do not depart from the scope of the invention as disclosed herein. For example, herein is describes heat treating a glass boule that has a diameter and a thickness, or glass cores taken from a boule, a glass of any shape having a thickness can be treated according to the invention, For example, the glass can be rectangular, square, octagonal, hexagonal, oblate, and so forth. Accordingly, the scope of the invention should be limited only by the attached claims.

We claim:

1. A method for preparing silica-titania having reduced striae and reduced inclusions, said method comprising:
preparing a silica-titania glass boule according to any method known in the art that utilizes both oscillation pattern and a rotational pattern during said preparation, wherein said oscillation pattern during said preparation repeats itself in a time of 10 minutes or less;
heat treating the glass boule a in a furnace at a temperature greater than 1600° C. for a time in the range of 48-160 hours to striae in said boule
cooling the glass to ambient temperature to yield a silica-titania glass boule having reduced striae;
placing the boule upside-down on a bed of a refractory material in a furnace;
heating the boule to a temperature of 1000° C. at a heating rate of 20-60° C.;
heating the boule to a temperature in the range of 1650-1700° C. at a rate in the range of 40-100° C., with slow-down in heating rate as the temperature approaches 1650° C.;
holding the boule at a temperature in the 1650-1700° C. for a time in the range of 4-10 days; and
cooling the boule to ambient temperature to obtain a silica-titania glass boule having reduced inclusions relative to a boule that is not heat treated at a temperature in the 1650-1700° C. for a time in the range of 4-10 days.

2. The method according to claim 1, wherein said boule on a bed of refractory material is heated at a temperature in the range of 1650-1660° C. for a time in the range of 5-7 days.

3. The method according to claim 1, wherein after the boule is heated at 1650-1700° C. for 4-10 days, said boule is cooled to 1000° C. at a rate in the range of 20-75° C. and then cooled to ambient temperature at the furnace's natural cooling rate.

4. A method for reducing inclusions in a boule of silica-titania glass, said method comprising:
obtaining a silica-titania glass boule;
placing the boule in a furnace;
heating the boule to a temperature of approximately 1000° C. at a heating rate in the range of 20-60° C./hr;
heating the boule to a temperature in the range of 1650-1700° C. at a rate in the range of 40-100° C., with slow-down in heating rate as the temperature approaches 1650° C.;
holding the boule at a temperature in the 1650-1700° C. for a time in the range of 4-10 days; and
cooling the boule to ambient temperature to obtain a silica-titania glass boule having reduced inclusions relative to a boule that is not heat treated at a temperature in the 1650-1700° C. for a time in the range of 4-10 days.

5. The method according to claim 4, wherein the boule is heated to a temperature in the range of 1650-1660° C.

6. The method according to claim 4, wherein placing the boule in a furnace means placing the boule upside-down on a bed of refractory material in the furnace.

7. The method according to claim 4, where in the heating is for a time in the range of 5-7 days.

8. The method according to claim 5, wherein said method further included periodic temperature spikes to approximately 1700° C.

9. A method for reducing inclusions in a boule of silica-titania glass, said method consisting of:
obtaining a silica-titania glass boule;
turning the boule upside-down such that the faces that were the top and bottom faces during manufacturing are reversed when the boule is placed on a surface;
placing the boule in said upside-down position on a bed of crushed refractory material in a furnace;
heating the boule to a temperature of approximately 1000° C. at a heating rate in the range of 20-60° C./hr while rotating and oscillating the boule;
heating the boule to a temperature in the range of 1650-1700° C. at a rate in the range of 40-100° C., with slow-down in heating rate as the temperature approaches 1650° C. while rotating and oscillating the boule;
holding the boule at a temperature in the 1650-1700° C. for a time in the range of 4-10 days while rotating and oscillating the boule; and
cooling the boule to ambient temperature by turning off the heat to the furnace and allowing the to obtain a silica-titania glass boule having reduced inclusions relative to a boule that is not heat treated at a temperature in the 1650-1700° C. for a time in the range of 4-10 days.
